(19) United States
(12) Patent Application Publication
(10) Pub. No.: US 2025/0059397 A1
(43) Pub. Date: Feb. 20, 2025

(54) METHOD FOR PRODUCING WATER-BASED POLYESTER RESIN, AND WATER-BASED POLYESTER RESIN, AND METHOD FOR PRODUCING WATER-BASED COATING COMPOSITION, AND WATER-BASED COATING COMPOSITION

(71) Applicant: GOO CHEMICAL CO., LTD., Kyoto (JP)

(72) Inventors: Teru SAKAKIBARA, Kyoto (JP); Kazuhiro TANAGAWA, Kyoto (JP)

(21) Appl. No.: 18/723,465

(22) PCT Filed: Dec. 23, 2022
(86) PCT No.: PCT/JP2022/047543

§ 371 Date: Jun. 24, 2024

(30) Foreign Application Priority Data
Jan. 13, 2022 (JP) 2022-003933

(51) Int. Cl. C09D 167/02; C08G 63/127; C08G 63/78; C08J 11/26

(52) U.S. Cl. CPC C09D 167/02; C08G 63/127; C08G 63/78; C08J 11/26; C08J 2367/02

(57) ABSTRACT

A method for producing a water-based polyester resin includes a first step, a second step, and a third step. The first step includes performing an ester formation reaction and a depolymerization reaction using a recycled polyester, a first polycarboxylic acid component, and a polyalcohol component. The second step includes performing an ester formation reaction using a reaction product of the first step and a second polycarboxylic acid component. The third step includes performing a polycondensation reaction by reducing pressure. The first step includes using the recycled polyester to such an amount that makes proportion of a terephthalic acid residue equal to or greater than 20% by mass and equal to or less than 72% by mass. The water-based polyester resin thus produced has an acid value equal to or greater than 30 mgKOH/g and equal to or less than 120 mgKOH/g.

### TECHNICAL FIELD

The present disclosure generally relates to a method for producing a water-based polyester resin, and a water-based polyester resin and a method for producing a water-based coating composition, and a water-based coating composition. More particularly, the present disclosure relates to a method for producing a water-based polyester resin including a terephthalic acid residue derived from a recycled polyester, and such a water-based polyester resin, and a method for producing a water-based coating composition containing such a water-based polyester resin, and such a water-based coating composition.

### BACKGROUND ART

It has been proposed that a water-based polyester resin, which is dispersible in either water or water containing a hydrophilic solvent, should be produced, from the viewpoint of environmental friendliness, by using a recycled polyester as a material and copolymerizing a hydrophilic component thereof (see Patent Documents 1-4). However, the water-based polyester resin produced by any of the methods of these documents tends to exhibit relatively low water dispersibility. In addition, it is also difficult to keep the water-based polyester resin dispersed in the liquid for a long time. In other words, the resin dispersion liquid thereof tends to have relatively low stability.

These tendencies are displayed probably for the following reasons, for example. Firstly, the main component of the recycled polyester is polyethylene terephthalate (PET), which is a resin with a high degree of crystallinity. Secondly, the molecular weight of recycled polyesters currently available is not uniform but varies depending on the type of the waste polyester material to be recycled or the method of conducting post-treatment on the waste polyester material. That is to say, these tendencies would have something to do with, for example, the rigidity of the molecular structure of the water-based polyester resin and the varying degree of depolymerization reaction produced in the recycled polyester during its production process.

On the other hand, examples of methods for improving the water dispersibility of the water-based polyester resin and the stability of a resin dispersion liquid thereof include lowering the compound ratio of the recycled polyester and adding a surfactant as a dispersing aid to the resin dispersion liquid. However, from the viewpoint of environmental friendliness, it is preferable that the compound ratio of the recycled polyester be as high as possible. In addition, if a surfactant is used, the surfactant may bleed out onto a resin film formed out of the resin dispersion liquid, thus sometimes causing a decline in the physical properties of the resin film or contaminating other materials when the surfactant comes into contact with the materials. Moreover, the use of a dissimilar material such as a surfactant causes a decrease in the recyclability of the material, leading to an increase in environmental impact.

As can be seen, there has been an increasing demand for producing, based on a recycled polyester, a water-based polyester resin which exhibits not only excellent water dispersibility even in the absence of any surfactant, for example, but also excellent stability when used as a resin dispersion liquid. In addition, the water-based polyester resin produced using the recycled polyester is sometimes required to have not only excellent water resistance but also properties comparable to a water-based polyester resin produced using non-recycled terephthalic acid or a terephthalic acid derivative not derived from the recycled polyester. In particular, the water-based polyester resin is required to have good adhesion to resins and metals and excellent transparency (e.g., its haze should be sufficiently low). Furthermore, the dispersion liquid of the water-based polyester resin is required to exhibit not only excellent water dispersibility for a long term but also improved stability such as aging stability in solution haze.

### CITATION LIST

### Patent Literature

Patent Document 1: JP H05-271612 A

Patent Document 2: JP 2001-505608 A

Patent Document 3: JP 2005-517050 A

Patent Document 4: JP 2004-163808 A

### SUMMARY OF INVENTION

The problem to be overcome by the present disclosure is to provide a method for producing a water-based polyester resin having the following advantageous features, and such a water-based polyester resin and a method for producing a water-based coating composition, and a water-based coating composition. Specifically, the water-based polyester resin to be provided by the present disclosure would exhibit not only excellent water resistance and excellent water dispersibility but also excellent stability when used as a resin dispersion liquid while reducing the environmental impact. In addition, the water-based polyester resin includes a terephthalic acid residue derived from a recycled polyester and would still have as good resin properties (such as adhesion and transparency) as in a situation where terephthalic acid or a terephthalic acid derivative not derived from a recycled polyester is used. Furthermore, the resin dispersion liquid of the water-based polyester resin would exhibit not only excellent water dispersibility for a long term but also improved stability such as aging stability in solution haze.

A method for producing a water-based polyester resin according to an aspect of the present disclosure is a method for producing a water-based polyester resin using a recycled polyester. The method includes a first step, a second step, and a third step. The first step includes performing an ester formation reaction and a depolymerization reaction using the recycled polyester, a first polycarboxylic acid component including a divalent polycarboxylic acid residue other than a terephthalic acid residue, and a polyalcohol component. The second step includes performing an ester formation reaction using a reaction product of the first step and a second polycarboxylic acid component including a trivalent or higher valent polycarboxylic acid residue. The third step includes performing a polycondensation reaction by reducing pressure. The first step includes using the recycled polyester to such an amount that makes proportion of the terephthalic acid residue with respect to a total of the terephthalic acid residue included in the recycled polyester and the respective polycarboxylic acid residues included in the first and second polycarboxylic acid components equal to or greater than 20% by mass and equal to or less than 72% by mass. The water-based polyester resin thus produced has an acid value equal to or greater than 30 mgKOH/g and equal to or less than 120 mgKOH/g.

A water-based polyester resin according to another aspect of the present disclosure contains: a terephthalic acid residue derived from a recycled polyester: and a polycarboxylic acid residue other than the terephthalic acid residue. The polycarboxylic acid residue includes a first polycarboxylic acid residue and a second polycarboxylic acid residue. The first polycarboxylic acid residue is divalent. The second polycarboxylic acid residue is trivalent or higher valent. Proportion of the terephthalic acid residue with respect to a total of the terephthalic acid residue, the first polycarboxylic acid residue, and the second polycarboxylic acid residue is equal to or greater than 20% by mass and equal to or less than 72% by mass. The water-based polyester resin has an acid value equal to or greater than 30 mgKOH/g and equal to or less than 120 mgKOH/g.

A method for producing a water-based coating composition according to still another aspect of the present disclosure includes the above-described method for producing the water-based polyester resin; and neutralizing, with a base, at least a part of a carboxy group of the water-based polyester resin.

A water-based coating composition according to yet another aspect of the present disclosure contains a water-based polyester resin. The water-based polyester resin includes a neutralized product of the water-based polyester resin described above.

### DESCRIPTION OF EMBODIMENTS

### Method for Producing Water-Based Polyester Resin

A method for producing a water-based polyester resin according to an exemplary embodiment (hereinafter referred to as a “production method (X)”) is a method for producing a water-based polyester resin using a recycled polyester. The production method (X) includes a first step, a second step, and a third step.

The production method (X) according to this embodiment enables producing a water-based polyester resin having the following advantageous features. Specifically, the water-based polyester resin would exhibit not only excellent water resistance and water dispersibility but also excellent stability when used as a resin dispersion liquid while reducing the environmental impact. In addition, the water-based polyester resin includes a terephthalic acid residue derived from a recycled polyester and would still have as good resin properties (such as adhesion and transparency) as in a situation where terephthalic acid or a terephthalic acid derivative not derived from a recycled polyester is used. Furthermore, the resin dispersion liquid of the water-based polyester resin would exhibit not only excellent water dispersibility for a long term but also improved stability such as aging stability in solution haze. The present inventors discovered that the problem described above could be overcome by: using, when producing a water-based polyester resin using a recycled polyester, a trivalent or higher valent polycarboxylic acid compound, as well as the divalent polycarboxylic acid compound, as hydrophilic components; setting the proportion of the recycled polyester to use within a particular range; setting the acid value of the water-based polyester resin within a particular range; and compounding the trivalent or higher valent polycarboxylic acid compound at a particular point in time during the production process.

These advantages are achieved presumably for the following reasons, for example. Firstly, setting the proportion of the recycled polyester used at a certain value or more allows not only the amounts of fossil fuel derived materials used but also the wastes to be cut down, for example, thus contributing to reducing the environmental impact. In addition, a resin dispersion liquid of the water-based polyester resin to be produced may be prepared using either water or water containing a hydrophilic organic solvent and without using any surfactant, for example, which also contributes to reducing the environmental impact. Furthermore, setting the proportion of the recycled polyester to use within a particular range and setting the acid value of the water-based polyester resin within a particular range using a trivalent or higher valent polycarboxylic acid compound would allow the water-based polyester resin to strike a proper balance in proportion between the hydrophobic and hydrophilic parts thereof, have excellent water dispersibility even in the absence of any surfactant, for example, and improve not only the stability of the resin dispersion liquid thereof but also the water resistance thereof as well. Furthermore, using, in the production method (X), the trivalent or higher valent polycarboxylic acid compound in the second step after the first step in which the divalent polycarboxylic acid compound is used would reduce the chances of forming a crosslinked structure in the water-based polyester resin obtained and allow the acid value to fall within a particular range. Another imaginable reason is that allowing the recycled polyester and the divalent polycarboxylic acid compound to react with each other in the first step allows the depolymerization reaction to be performed appropriately on recycled polyesters with various molecular weights. Furthermore, for the same reasons why the above-described water-based polyester resin has excellent water dispersibility and its resin dispersion liquid has excellent stability, the resin properties such as adhesion and transparency, the water dispersibility for a long term, and its stability such as aging stability in solution haze would also be improved equally significantly, no matter whether the terephthalic acid residue is derived from the recycled polyester or formed out of unused terephthalic acid or terephthalic acid derivative.

The water-based polyester resin (hereinafter also referred to as “resin (Y)”) produced by the production method (X) is a polyester resin and has a structural unit consisting of a polycarboxylic acid residue and a structural unit consisting of a polyalcohol residue. The polycarboxylic acid residue contained in either the resin (Y) or the polycarboxylic acid component is usually expressed by the following formula (1). The polyalcohol residue contained in either the resin (Y) or polyalcohol component is usually expressed by the following formula (2). The resin (Y) has a terephthalic acid residue derived from the recycled polyester as a structural unit consisting of a polycarboxylic acid residue.

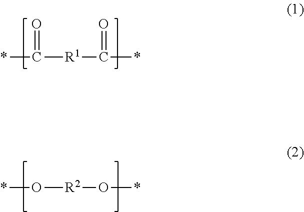

In formula (1), R¹ is a substituted or non-substituted hydrocarbon group having 1 to 50 carbon atoms.

In formula (2), R² is a substituted or non-substituted hydrocarbon group having 1 to 50 carbon atoms.

In formulae (1) and (2), * indicates either a group adjacent to the residue expressed by formula (1) or (2) or a site that bonds to the adjacent residue.

Examples of substituents for the hydrocarbon groups in R¹ and R² include hydroxy groups such as an alcoholic hydroxy group and a phenolic hydroxy group, a carboxy group, an acyl group, an acyloxy group, a halogen atom, an alkoxy group, and an alkoxy carbonyl group.

Examples of compounds that produce the polycarboxylic acid residue include a first polycarboxylic acid component and a second polycarboxylic acid component. As used herein, the “first polycarboxylic acid component” refers to a compound including a divalent polycarboxylic acid residue other than a terephthalic acid residue and may be, for example, at least one selected from the group consisting of divalent polycarboxylic acids other than terephthalic acid and esters and anhydrides thereof. As used herein, the “second polycarboxylic acid component” refers to a compound including a trivalent or higher valent polycarboxylic acid residue and may be, for example, at least one selected from the group consisting of trivalent or higher valent polycarboxylic acids, and esters and anhydrides thereof. In the trivalent or higher valent polycarboxylic acid residue produced by the second polycarboxylic acid component, the hydrocarbon group R¹ in formula (1) usually has a single or a plurality of carboxy groups as substituent(s).

Examples of such compounds that produce the polyalcohol residue include dihydric polyalcohol compounds and trihydric or higher hydric polyalcohol compounds. In the trihydric or higher hydric polyalcohol residue produced by the trihydric or higher hydric polyalcohol compound, the hydrocarbon group R² in formula (2) usually has a single or a plurality of alcoholic hydroxy groups as substituent(s).

Next, the respective steps will be described.

### [First Step]

The first step includes performing an ester formation reaction and a depolymerization reaction using a recycled polyester, a first polycarboxylic acid component, and a polyalcohol component.

As used herein, the “ester formation reaction” refers to a reaction through which a polycarboxylic acid component and a polyalcohol component form an ester compound by, for example, dehydration condensation or dealcoholization condensation.

The “depolymerization reaction” as used herein refers to a reaction of forming a polyester with a lower molecular weight from a recycled polyester and a polycarboxylic acid component, a polyalcohol component, or an ester compound formed therefrom.

In the first step, all components of the reaction materials for use in the first step may be compounded at a time, or one or more components or a certain amount of components that form part of the reaction materials may be compounded sequentially. Alternatively, after some of the reaction materials have been compounded and then the reaction is produced, some others of the reaction materials may be compounded, and then the reaction may be further produced. These compounding and reaction processes may be repeated.

In the first step, after the recycled polyester, the first polycarboxylic acid component, and the polyalcohol component have been compounded with each other, the ester formation reaction and the depolymerization reaction may be performed. Alternatively, after the first polycarboxylic acid component and the polyalcohol component have been compounded with each other, the ester formation reaction may be performed, the recycled polyester may be added to the reaction product, and then the depolymerization reaction may be performed.

The reaction materials are usually compounded in an apparatus, such as a reactor, for performing the production method (X).

The respective reaction materials for use in the first step will be described one by one below.

### (Recycled Polyester)

The recycled polyester contains polyethylene terephthalate as a main component thereof. As used herein, the “main component” refers to a component with the largest content ratio. The proportion of polyethylene terephthalate with respect to the recycled polyester is preferably equal to or greater than 90% by mass, more preferably equal to or greater than 95% by mass, and even more preferably equal to or greater than 99% by mass. This contributes to turning the water-based polyester resin into a substantially mono material. The proportion may even be 100% by mass.

Examples of the recycled polyester include material recycled polyesters, mechanically recycled polyesters, and chemically recycled polyesters. As used herein, the “material recycled polyester” refers to a polyester obtained by subjecting used or waste polyester molded products such as bottles, containers, and films to sorting, pulverization, washing, and other processes for removing contaminants and foreign particles and then turning these products thus treated into flakes. As used herein, the “mechanically recycled polyester” refers to a polyester, from which contaminants inside the resin have been removed by treating those flakes of the material recycled polyester under a high-temperature and reduced-pressure environment, for example, for a certain period of time and of which the degree of polymerization is adjusted by repolymerizing a part of the polyester. As used herein, the “chemically recycled polyester” refers to a polyester obtained by decomposing a polyester down to the monomer level and then repolymerizing the monomers.

The intrinsic viscosity (IV value, unit: dl/g) of the recycled polyester is preferably equal to or greater than 0.40 and equal to or less than 1.20, and more preferably equal to or greater than 0.45 and equal to or less than 1.00, to perform the depolymerization reaction more appropriately in the first step. The intrinsic viscosity is generally used as an index to the degree of polymerization of a polymer.

The recycled polyester preferably contains at least one of the material recycled polyester or the mechanically recycled polyester from the viewpoint of further reducing the environmental impact. From the viewpoint of improving the quality of the water-based polyester resin, the recycled polyester more preferably contains the mechanically recycled polyester, and even more preferably contains a mechanically recycled polyester obtained by recovering PET bottles, PET films, or polyester fibers (PET fibers).

### (First Polycarboxylic Acid Component)

The first polycarboxylic acid component includes at least one selected from the group consisting of divalent polycarboxylic acids, other than terephthalic acids, including divalent polycarboxylic acid residues other than terephthalic acid residues, for example, and esters and anhydrides thereof.

Examples of the first polycarboxylic acid component include dicarboxylic acids including: aromatic dicarboxylic acids such as phthalic acid, isophthalic acid, 2,6-naphthalene dicarboxylic acid, 2,7-naphthalene dicarboxylic acid, 1,4-naphthalene dicarboxylic acid, and 2,5-furandicarboxylic acid; alicyclic dicarboxylic acids such as 1,4-cyclohexane dicarboxylic acid; and aliphatic dicarboxylic acids such as succinic acid, adipic acid, sebacic acid, and dodecanedioic acid, and esters and anhydrides thereof.

From the viewpoint of reducing the environmental impact, it is also preferable to use a biomass-derived first polycarboxylic acid component. Examples of the biomass-derived first polycarboxylic acid component include 2,5-furandicarboxylic acid, succinic acid, adipic acid, and sebacic acid.

From the viewpoint of further improving the water dispersibility of the resin (Y) and the stability of the resin dispersion liquid thereof by more adequately lowering the degree of crystallinity of the water-based polyester resin, the first polycarboxylic acid component preferably contains at least one selected from the group consisting of aromatic dicarboxylic acids and esters and anhydrides thereof, and more preferably contains at least one selected from the group consisting of isophthalic acid and 2,6-naphthalene dicarboxylic acid.

The first polycarboxylic acid component preferably contains no metal-sulfonate-group-containing polycarboxylic acid compounds such as metal-sulfonate-group-containing polycarboxylic acids, and esters and anhydrides thereof. Using the metal-sulfonate-group-containing polycarboxylic acid may cause a decline in the water resistance of the resin (Y). As used herein, the “metal sulfonate group” refers to a metal base of a sulfo group (—SO₃H), and may be expressed by, for example, —SO₃⁻(Mⁿ⁺)_{1/n} (where Mⁿ⁺is an n-valent metal cation, and n is an integer falling within the range from 1 to 6). Examples of metal cations include alkaline metal ions such as a sodium ion and a potassium ion. Examples of the metal-sulfonate-group-containing polycarboxylic acid compound include 5-sodium sulfoisophthalate and 5-sodium dimethyl sulfoisophthalate. The first polycarboxylic acid component containing no metal-sulfonate-group-containing polycarboxylic acid compounds reduces the chances of causing a decline in the water resistance of the resin (Y).

### (Polyalcohol Component)

The resin (Y) usually contains, as a polyalcohol residue, an ethylene glycol residue derived from a recycled polyester.

Examples of the polyalcohol components include dihydric alcohol compounds and trihydric or higher hydric alcohol compounds.

Examples of the dihydric alcohol compounds include: aliphatic diols such as ethylene glycol, 1,2-propanediol, 1,3-propanediol, 1,3-butanediol, 1,4-butanediol, neopentyl glycol, and 1,6-hexanediol; alicyclic diols such as 1,4-cyclohexanedimethanol; aromatic diols such as 1,4-benzenedimethanol and 9,9-bis[4-(2-hydroxyethoxy)phenyl] fluorene; and ether-group-containing diols including diethylene glycol, polyethylene glycol, dipropylene glycol, polypropylene glycol, and polytetramethylene ether glycol.

The dihydric alcohol compound preferably includes a dihydric alcohol compound having a branched chain. This allows the resin dispersion liquid of the resin (Y) to further improve its stability such as aging stability in solution haze.

Examples of the dihydric alcohol compound having a branched chain include a compound expressed by the following formula (3):

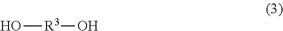

In formula (3), R³ is a branched-chain divalent hydrocarbon group having 3 to 50 carbon atoms.

Examples of the branched-chain divalent hydrocarbon group represented by R³ include a propane-1,2-diyl group, a butane-1,2-diyl group, a butane-1,3-diyl group, a 2-methylpropane-1,3-diyl group, a pentane-1,2-diyl group, a pentane-1,3-diyl group, a pentane-1,4-diyl group, a 2,2-dimethylpropane-1,3-diyl group, a 2-methylbutane-1,4-diyl group, a hexane-1,2-diyl group, a hexane-2,5-diyl group, and a 2,4-diethylpentane-1,5-diyl group.

Examples of the branched-chain dihydric alcohol compound include neopentyl glycol, 1,2-propanediol, 1,2-butanediol, 1,3-butanediol, 1,2-pentanediol, 1,2-hexanediol, 2,5-hexanediol, and 2,4-diethyl-1,5-pentanediol. Among other things, neopentyl glycol, 1,2-propanediol, and 1,3-butanediol are particularly preferred.

Examples of trihydric or higher hydric alcohol compounds include triol compounds including: aliphatic triols such as glycerin and trimethylolpropane; alicyclic triols such as 1,2,4-cyclohexanetrimethanol; and aromatic triols such as benzene trimethanol; and tetrol compounds such as pentaerythritol.

The polyalcohol component preferably contains no trihydric or higher hydric polyalcohol compounds. This allows the resin (Y) to have an even smaller number of crosslinked structures formed due to the presence of the trihydric or higher hydric polyalcohol compound. Consequently, the water dispersibility of the resin and the stability of the resin dispersion liquid thereof are further improvable.

From the viewpoint of reducing the environmental impact, it is also preferable to use a biomass-derived polyalcohol component. Examples of the biomass-derived polyalcohol component include ethylene glycol, 1,3-propanediol, 1,3-butanediol, and 1,4-butanediol.

It is important to use, in the first step, the recycled polyester to such an amount that makes the proportion of the terephthalic acid residue included in the recycled polyester with respect to the total of the terephthalic acid residue included in the recycled polyester and the respective polycarboxylic acid residues included in the first and second polycarboxylic acid components equal to or greater than 20% by mass and equal to or less than 72% by mass. If the proportion were less than 20% by mass, the environmental impact would be reduced insufficiently. If the proportion were greater than 72% by mass, the resin (Y) would not have a lower degree of crystallinity but have decreased water dispersibility. The proportion is preferably equal to or greater than 30% by mass, more preferably equal to or greater than 40% by mass, even more preferably equal to or greater than 45% by mass, and particularly preferably equal to or greater than 50% by mass. The proportion is preferably equal to or less than 71% by mass, more preferably equal to or less than 70% by mass, even more preferably equal to or less than 69% by mass, and particularly preferably equal to or less than 68% by mass.

The first step preferably includes using the first polycarboxylic acid component to such an amount that makes the proportion of the divalent polycarboxylic acid residue with respect to the total of the terephthalic acid residue included in the recycled polyester and the respective polycarboxylic acid residues included in the first and second polycarboxylic acid components equal to or greater than 5% by mass and equal to or less than 50% by mass, for example. Setting the proportion within this range allows the resin (Y) to decrease the degree of crystallinity thereof more adequately and further improve the water dispersibility and the stability of the resin dispersion liquid thereof. The proportion is more preferably equal to or greater than 10% by mass, even more preferably equal to or greater than 14% by mass, and particularly preferably equal to or greater than 18% by mass. The proportion is more preferably equal to or less than 40% by mass, even more preferably equal to or less than 30% by mass, and particularly preferably equal to or less than 26% by mass.

If the polyalcohol component includes a dihydric alcohol compound having a branched chain, then the dihydric alcohol compound is preferably used to such an amount that makes the proportion of the residue of the dihydric alcohol compound having the branched chain with respect to the entire polyalcohol residue included in the resin (Y) equal to or greater than 10% by mass and equal to or less than 90% by mass. This allows the resin dispersion liquid of the resin (Y) to further improve its stability such as aging stability in solution haze. The proportion is preferably equal to or greater than 15% by mass and equal to or less than 85% by mass, more preferably equal to or greater than 20% by mass and equal to or less than 80% by mass, and even more preferably equal to or greater than 25% by mass and equal to or less than 75% by mass.

If the polyalcohol component includes a polyalcohol compound other than ethylene glycol, the proportion of the ethylene glycol with respect to the entire polyalcohol component is preferably equal to or greater than 20% by mass. This promotes the depolymerization reaction of the recycled polyester. The proportion is more preferably equal to or greater than 25% by mass, even more preferably equal to or greater than 30% by mass, and particularly preferably equal to or greater than 35% by mass. The proportion may even be 100% by mass. That is to say, from the viewpoint of promoting the depolymerization reaction of the recycled polyester, the proportion of the additional polyalcohol compound with respect to the entire polyalcohol component is preferably equal to or less than 80% by mass, more preferably equal to or less than 75% by mass, even more preferably equal to or less than 70% by mass, and particularly preferably equal to or less than 65% by mass. The proportion may even be 0% by mass.

In the first step, at least one selected from the group consisting of terephthalic acid and its esters and anhydrides and at least one selected from the group consisting of hydroxycarboxylic acid and its esters and anhydrides may be used besides the recycled polyester, the first polycarboxylic acid component, and the polyalcohol component, as far as the advantages of the present disclosure are not impaired, but are preferably not used.

The reaction in the first step may be promoted by, for example, heating the reaction materials compounded.

In the first step, it is preferable to use a catalyst from the viewpoint of promoting the reaction. Examples of the catalyst include titanium oxalate salts such as potassium titanium oxalate and sodium titanium oxalate; titanium alkoxides such as tetra-n-propyl titanate and tetra-n-butyl titanate; fatty acid titanium salts such as titanium acetate; titanium catalysts such as inorganic titanium compounds including titanium oxides; fatty acid manganese salts such as manganese acetate; manganese catalysts such as manganese carbonate; antimony catalysts such as antimony trioxide; aluminum catalysts such as aluminum tris (acetyl acetate); germanium catalysts such as germanium dioxide; and lithium catalysts such as sec-butyllithium.

The amount of the catalyst used may be, for example, equal to or greater than 0.0001% by mass and equal to or less than 0.1% by mass, and is preferably equal to or greater than 0.003% by mass and equal to or less than 0.05% by mass, with respect to all the components compounded in the first step.

To cause the reaction in the first step, a reaction solvent may or may not be used, but is preferably not used.

From the viewpoint of improving the quality of the resin (Y), the reaction in the first step is preferably performed in an inert gas atmosphere such as a nitrogen atmosphere or an argon atmosphere.

The first step may be performed, for example, in either of the following two procedures (A) and (B):
(A) The first step may include performing an ester formation reaction and a depolymerization reaction after the recycled polyester, the first polycarboxylic acid component, and the polyalcohol component have been compounded with each other; or
(B) The first step may include: the step of performing the ester formation reaction after the first polycarboxylic acid component and the polyalcohol component have been compounded with each other; and the step of performing the depolymerization reaction after the recycled polyester has been added to the reaction product.

### [Procedure (A)]

According to the procedure (A), the first step includes performing, after having compounded the recycled polyester, the first polycarboxylic acid component, and the polyalcohol component with each other as reaction materials, the step of performing an ester formation reaction and a depolymerization reaction on the reaction materials thus compounded (hereinafter referred to as a “step X1”). This procedure (A) allows the resin (Y) to be produced by a simpler method.

The reaction temperature in the step X1 is preferably equal to or higher than 150° C. and equal to or lower than 270° C., and more preferably equal to or higher than 180° C. and equal to or lower than 260° C. The reaction duration is preferably equal to or longer than 1 hour and equal to or shorter than 10 hours, and more preferably equal to or longer than 2 hours and equal to or shorter than 8 hours. From the viewpoint of further promoting the ester formation reaction and depolymerization reaction in the step X1, the reaction system is preferably under ordinary pressure. The reaction temperature in the step X1 may be changed stepwise.

### [Procedure (B)]

According to the procedure (B), the first step includes: the step of performing, after having compounded a polycarboxylic acid component and a polyalcohol component as reaction materials, an ester formation reaction on the reaction materials thus compounded (hereinafter also referred to as a “step X2-1”); and the step of adding a recycled polyester to the reaction product of the step X2-1 and then performing a depolymerization reaction (hereinafter also referred to as a “step X2-2”). According to the procedure (B), performing the compounding and reaction processes separately in these steps X2-1 and X2-2 allows, for example, a depolymerization reaction of the recycled polyester to be performed more appropriately, thus further improving the water dispersibility of the resin (Y) and the stability of the resin dispersion liquid thereof.

### (Step X2-1)

The step X2-1 includes performing an ester formation reaction after having compounded the polycarboxylic acid component and the polyalcohol component with each other.

The reaction temperature in the step X2-1 is preferably equal to or higher than 150° C. and equal to or lower than 250° C., and more preferably equal to or higher than 180° C. and equal to or lower than 240° C. The reaction duration is preferably equal to or longer than 1 hour and equal to or shorter than 8 hours, and more preferably equal to or longer than 2 hours and equal to or shorter than 5 hours. From the viewpoint of further promoting the ester formation reaction in the step X2-1, the reaction system is preferably under ordinary pressure. The reaction temperature in the step X2-1 may be changed stepwise.

### (Step X2-2)

The step X2-2 includes further adding the recycled polyester to the reaction product and then performing a depolymerization reaction to the compound.

The reaction temperature in the step X2-2 is preferably equal to or higher than 200° C. and equal to or lower than 270° C., and more preferably equal to or higher than 210° C. and equal to or lower than 260° C. The reaction duration is preferably equal to or longer than 1 hour and equal to or shorter than 8 hours, and more preferably equal to or longer than 2 hours and equal to or shorter than 7 hours. From the viewpoint of further promoting the depolymerization reaction in the step X2-2, the reaction system is preferably under ordinary pressure. The reaction temperature in the step X2-2 may be changed stepwise.

### [Second Step]

The second step includes performing an ester formation reaction using the reaction product of the first step and the second polycarboxylic acid component.

### (Second Polycarboxylic Acid Component)

The second polycarboxylic acid component includes at least one selected from the group consisting of, for example, a trivalent or higher valent polycarboxylic acid including a trivalent or higher valent polycarboxylic acid residue, and esters and anhydrides thereof.

Examples of the second polycarboxylic acid component include: aromatic tricarboxylic acids such as trimellitic acid, hemimellitic acid, trimesic acid, and 1,2,5-naphthalene tricarboxylic acid; alicyclic tricarboxylic acids such as a 1,2,4-cyclohexane tricarboxylic acid; aliphatic tricarboxylic acids such as a 1,2,3-butane tricarboxylic acid; tetravalent or higher valent polycarboxylic acids such as pyromellitic acid; and esters and anhydrides of these tricarboxylic acids and polycarboxylic acids.

The second step preferably includes using the second polycarboxylic acid component to such an amount that makes the proportion of the trivalent or higher valent polycarboxylic acid residue with respect to the total of the terephthalic acid residue included in the recycled polyester and the respective polycarboxylic acid residues included in the first and second polycarboxylic acid components equal to or greater than 10% by mass and equal to or less than 30% by mass. This makes the acid value of the resin (Y) a more adequate value. Consequently, this further improves the water resistance of the resin (Y), thus allowing the resin dispersion liquid of this resin (Y) to exhibit not only excellent water dispersibility for a long term but also improved stability such as aging stability in solution haze. The proportion is more preferably equal to or greater than 13% by mass, even more preferably equal to or greater than 15% by mass, and particularly preferably equal to or greater than 17% by mass. The proportion is more preferably equal to or less than 27% by mass, even more preferably equal to or less than 25% by mass, and particularly preferably equal to or less than 23% by mass.

The second polycarboxylic acid component preferably contains no metal-sulfonate-group-containing polycarboxylic acid compounds such as metal-sulfonate-group-containing polycarboxylic acid and the esters and anhydrides thereof. The second polycarboxylic acid component containing no metal-sulfonate-group-containing polycarboxylic acid compounds reduces the chances of causing a decline in the water resistance of the resin (Y).

From the viewpoint of reducing the environmental impact, the proportion of the recycled polyester used with respect to the total amount of materials used for producing the water-based polyester resin is preferably as large as possible. Specifically, the recycled polyester is preferably used to such an amount that makes the proportion of the recycled polyester for use to produce the resin (Y) with respect to the total of the recycled polyester, the polycarboxylic acid component, and the polyalcohol component equal to or greater than 20% by mass and equal to or less than 72% by mass. The proportion is more preferably equal to or greater than 30% by mass, and even more preferably equal to or greater than 40% by mass. The proportion is more preferably equal to or less than 65% by mass, and even more preferably equal to or less than 62% by mass.

Also, from the viewpoint of reducing the environmental impact, the proportion of the polyalcohol component used with respect to the total amount of materials used for producing the resin (Y) is preferably as small as possible. Specifically, the polyalcohol component is preferably used to such an amount that makes the proportion of the polyalcohol component with respect to the total of the recycled polyester, the polycarboxylic acid component, and the polyalcohol component equal to or greater than 10% by mass and equal to or less than 40% by mass. The proportion is more preferably equal to or less than 35% by mass, and even more preferably equal to or less than 30% by mass. The proportion is more preferably equal to or greater than 13% by mass, and even more preferably equal to or greater than 15% by mass.

More moles of the polyalcohol component are preferably used to produce the resin (Y) than the polycarboxylic acid component. This further promotes the depolymerization reaction of the recycled polyester. Specifically, the molar ratio of the polyalcohol component to the polycarboxylic acid component (polyalcohol component/polycarboxylic acid component) is preferably equal to or greater than 1.1 to 1 and equal to or less than 5 to 1. The molar ratio of the polyalcohol component to the polycarboxylic acid component is more preferably equal to or greater than 1.3 to 1 and equal to or less than 4.0 to 1, even more preferably equal to or greater than 1.5 to 1 and equal to or less than 3.5 to 1, and particularly preferably equal to or greater than 1.7 to 1 and equal to or less than 3.0 to 1.

After the reaction has been performed in the first step, the second step may be performed continuously with the second polycarboxylic acid component added to the reaction system. Alternatively, the second step may also be performed by isolating the reaction product of the first step and adding a catalyst, a solvent, or any other additive thereto as needed.

In the second step, it is preferable to use a catalyst from the viewpoint of promoting the reaction. The catalyst included in the reaction product may be used by using the reaction product of the first step as it is.

The reaction temperature in the second step is preferably equal to or higher than 150° C. and equal to or lower than 270° C., and more preferably equal to or higher than 160° C. and equal to or lower than 240° C. The reaction duration is preferably equal to or longer than 10 minutes and equal to or shorter than 3 hours, and more preferably equal to or longer than 20 minutes and equal to or shorter than 2 hours. From the viewpoint of further promoting the ester formation reaction in the second step, the reaction system is preferably under ordinary pressure. The reaction temperature in the second step may be changed stepwise.

### [Third Step]

The third step includes performing a polycondensation reaction by reducing pressure. In the third step, the polycondensation reaction is promoted by reducing the pressure in the reaction system and removing the polyalcohol and other products produced by the reaction.

As used herein, the “polycondensation reaction” refers to a reaction, through which the ester compound formed in the first and second steps and the polyester are subjected to, for example, a dealcoholization condensation reaction to form a polyester having a higher molecular weight.

The reaction in the third step may be promoted by reducing the pressure in the reaction system and by, for example, heating the reaction product of the second step.

After the reaction has been performed in the second step, the third step may be performed with the pressure in the reaction system kept reduced but with the temperature adjusted. Alternatively, the third step may also be performed by isolating the reaction product of the second step, adding a catalyst, a solvent, or any other additive thereto as needed, and then reducing the pressure in the reaction system and heating the reaction product, for example.

The degree of pressure reduction (absolute pressure) in the third step is preferably equal to or lower than 25 hPa, and more preferably equal to or lower than 10 hPa. The reaction temperature in the third step is preferably equal to or higher than 150° C. and equal to or lower than 270° C., and more preferably equal to or higher than 160° C. and equal to or lower than 240° C. The degree of pressure reduction and the reaction temperature in the third step may be changed stepwise. Adjusting the degree of pressure reduction, temperature, and duration in the third step allows the weight average molecular weight, acid value, or any other parameter of resin (Y) to be adjusted.

A water-based polyester resin (resin (Y)) may be obtained by performing the production method (X) described above.

### (Acid Value)

It is important that the resin (Y) thus obtained has an acid value equal to or greater than 30 mgKOH/g and equal to or less than 120 mgKOH/g. Setting the acid value of the resin (Y) at a value equal to or greater than 30 mgKOH/g allows the resin (Y) to have excellent water dispersibility. Setting the acid value of the resin (Y) at a value equal to or less than 120 mgKOH/g allows the resin (Y) to have excellent water resistance. If the acid value were less than 30 mgKOH/g, then the water dispersibility would be insufficient. On the other hand, if the acid value were greater than 120 mgKOH/g, the water resistance would decrease. The acid value is preferably equal to or greater than 33 mgKOH/g, more preferably equal to or greater than 35 mgKOH/g, and even more preferably equal to or greater than 40 mgKOH/g. The acid value is preferably equal to or less than 110 mgKOH/g, more preferably equal to or less than 100 mgKOH/g, and even more preferably equal to or less than 90 mgKOH/g. As used herein, the “acid value” of the resin (Y) refers to the mass (mg) of potassium hydroxide required to neutralize 1 g of the resin (Y). The acid value of the resin (Y) is a value determined by, for example, the presence of a carboxy group on the side chain or end of a molecule of the resin (Y).

### (Glass Transition Temperature)

The glass transition temperature (Tg) of the resin (Y) thus obtained is preferably equal to or higher than 0° C. and equal to or lower than 100° C. Setting Tg at a temperature equal to or higher than 0° C. reduces the chances of the resin (Y) being too viscous, thus making it even easier to handle the resin (Y) and further reducing the chances of causing excessive tackiness. Setting Tg at a temperature equal to or lower than 100° C. allows the resin (Y) to have better film-forming ability, an increased degree of adhesion to a base member, and improved primer properties. Tg is more preferably equal to or higher than 10° C. and even more preferably equal to or higher than 20° C. Tg is more preferably equal to or lower than 90° C. and even more preferably equal to or lower than 85° C.

The weight average molecular weight of the resin (Y) thus obtained is preferably equal to or greater than 2,000 and equal to or less than 100,000, more preferably equal to or greater than 3,000 and equal to or less than 50,000, and even more preferably equal to or greater than 4,000 and equal to or less than 30,000.

### Water-Based Polyester Resin

A resin (Y) according to this embodiment includes a terephthalic acid residue (hereinafter also referred to as a “residue (I)”) derived from a recycled polyester and a polycarboxylic acid residue (hereinafter also referred to as a “residue (II)”) other than the terephthalic acid residue. The residue (II) includes a divalent first polycarboxylic acid residue (hereinafter also referred to as a “residue (IIa)”) and a trivalent or higher valent second polycarboxylic acid residue (hereinafter also referred to as a “residue (IIb)”). The proportion of the residue (I) with respect to the total of the residue (I), the residue (IIa), and the residue (IIb) is equal to or greater than 20% by mass and equal to or less than 72% by mass. The resin (Y) has an acid value equal to or greater than 30 mgKOH/g and equal to or less than 120 mgKOH/g.

The resin (Y) exhibits not only excellent water resistance and excellent water dispersibility but also excellent stability when used as a resin dispersion liquid while reducing the environmental impact. In addition, the resin (Y) includes a terephthalic acid residue derived from a recycled polyester and still has as good resin properties (such as adhesion and transparency) as in a situation where terephthalic acid or a terephthalic acid derivative not derived from a recycled polyester is used. Furthermore, the resin dispersion liquid of the resin (Y) exhibits not only excellent water dispersibility for a long term but also improved stability such as aging stability in solution haze.

The resin (Y) includes a polycarboxylic acid residue and a polyalcohol residue.

### (Polycarboxylic Acid Residue)

The resin (Y) includes the residue (I) and the residue (II) as the polycarboxylic acid residues.

### (Residue (I))

The residue (I) is a terephthalic acid residue derived from the recycled polyester. As used herein, the “terephthalic acid residue derived from the recycled polyester” means that the terephthalic acid residue included in the recycled polyester has turned into a terephthalic acid residue included in the resin (Y). As used herein, the “terephthalic acid residue” refers to a residue expressed by the following formula (4):

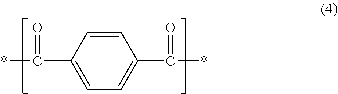

In the formula (4), * indicates either a group adjacent to the residue expressed by this formula (4) or a site bonding to an adjacent residue.

It is important that the proportion of the residue (I) with respect to the total of the residues (I), (IIa), and (IIb) in the resin (Y) is equal to or greater than 20% by mass and equal to or less than 72% by mass. The proportion is preferably equal to or greater than 30% by mass, more preferably equal to or greater than 40% by mass, even more preferably equal to or greater than 45% by mass, and particularly preferably equal to or greater than 50% by mass. The proportion is preferably equal to or less than 71% by mass, more preferably equal to or less than 70% by mass, even more preferably equal to or less than 69% by mass, and particularly preferably equal to or less than 68% by mass.

### (Residue (II))

The residue (II) includes a residue (IIa) and a residue (IIb).

### (Residue (IIa))

The residue (IIa) is a divalent polycarboxylic acid residue other than a terephthalic acid residue and will be hereinafter referred to as a “first polycarboxylic acid residue.”

It is preferable that the proportion of the residue (IIa) with respect to the total of the residues (I), (IIa), and (IIb) in the resin (Y) be equal to or greater than 5% by mass and equal to or less than 50% by mass. The proportion is more preferably equal to or greater than 10% by mass, even more preferably equal to or greater than 14% by mass, and particularly preferably equal to or greater than 18% by mass. The proportion is more preferably equal to or less than 40% by mass, even more preferably equal to or less than 30% by mass, and particularly preferably equal to or less than 26% by mass.

### (Residue (IIb))

The residue (IIb) is a trivalent or higher valent polycarboxylic acid residue and will be hereinafter referred to as a “second polycarboxylic acid residue.”

It is preferable that the proportion of the residue (IIb) with respect to the total of the residues (I), (IIa), and (IIb) in the resin (Y) be equal to or greater than 10% by mass and equal to or less than 30% by mass. The proportion is more preferably equal to or greater than 13% by mass, even more preferably equal to or greater than 15% by mass, and particularly preferably equal to or greater than 17% by mass. The proportion is more preferably equal to or less than 27% by mass, even more preferably equal to or less than 25% by mass, and particularly preferably equal to or less than 23% by mass.

### (Polyalcohol Residue)

The polyalcohol residue is a residue included in a polyalcohol compound having a plurality of alcoholic hydroxy groups. The resin (Y) usually has, as a polyalcohol residue, an ethylene glycol residue derived from a recycled polyester.

The polyalcohol residue preferably includes no residues of a trihydric or higher hydric polyalcohol compound. That is to say, the polyalcohol residue preferably includes only residues of a dihydric polyalcohol compound. This allows the resin (Y) to have an adequate number of crosslinked structures, thus further improving the water dispersibility of the resin (Y) and the stability and film-forming ability of the resin dispersion liquid thereof.

If the polyalcohol residue includes a residue of a dihydric alcohol compound, then the residue of the dihydric alcohol compound preferably has a branched chain. This allows the resin dispersion liquid of the resin (Y) to further improve its stability such as aging stability in solution haze.

If the polyalcohol residue includes a residue of a dihydric alcohol compound having a branched chain, then the proportion of the dihydric alcohol compound having the branched chain with respect to all polyalcohol residues included in the resin (Y) is preferably equal to or greater than 10% by mass and equal to or less than 90% by mass. This allows the resin dispersion liquid of the resin (Y) to further improve its stability such as aging stability in solution haze. The proportion is preferably equal to or greater than 15% by mass and equal to or less than 85% by mass, more preferably equal to or greater than 20% by mass and equal to or less than 80% by mass, and even more preferably equal to or greater than 25% by mass and equal to or less than 75% by mass.

### Method for Producing Water-Based Coating Composition

A water-based coating composition (hereinafter also referred to as a “composition (Z)”) is a composition including the water-based polyester resin (resin (Y)) described above. In the composition (Z), the resin (Y) is preferably dispersed uniformly. The resin (Y) may be dispersed more uniformly by neutralizing a carboxy group with a base.

A method (hereinafter referred to as a “production method (V)”) for producing the water-based coating composition according to this embodiment includes the production method (X) described above (i.e., the first, second, and third steps) and the step of neutralizing at least a part of a carboxy group of the water-based polyester resin with a base (hereinafter referred to as a “fourth step”). The production method (V) allows a composition (V), in which the resin (Y) is dispersed more uniformly, to be provided.

Examples of the base for use in the fourth step include: ammonia; organic bases including amines such as trimethyl amine, diethyl amine, and triethyl amine; and inorganic bases such as sodium hydroxide and sodium carbonate. Among other things, either ammonia or one of these organic bases is preferably used as the base, and any one of ammonia, trimethyl amine, diethyl amine, or triethyl amine is more preferably used as the base, because each of these bases allows, when a coating is formed out of the composition (Z) applied, the base to be removed by heating and a carboxy group to be reproduced, thus forming a coating with even better water resistance.

The amount of the base for use in neutralization is not limited to any particular value as long as the carboxy group of the resin (Y) may be neutralized at least partially. The amount of the base is preferably large enough to neutralize 50 mol % to 100 mol % of the carboxy group of the resin (Y) and more preferably large enough to neutralize 70 mol % to 100 mol % of the carboxy group of the resin (Y). Setting the amount of the base used at a value falling within one of these ranges allows a composition (Z) in which the resin (Y) is dispersed more uniformly to be provided.

The fourth step may include adding, for example, either water or water containing a hydrophilic organic solvent. In that case, the applicability of the composition (Z) may be further increased by, for example, appropriately adjusting the viscosity of the composition (Z). If the composition (Z) contains either water or water containing a hydrophilic organic solvent, then the composition (Z) is a resin dispersion liquid of the resin (Y). This resin dispersion liquid of the resin (Y) is excellent in stability and may keep the resin dispersed for a long time.

Examples of the hydrophilic organic solvent include: alcohols such as methanol, ethanol, 2-propanol, and 1,2-propanediol; glycol ethers such as propylene glycol monomethyl ether, ethyl cellosolve, and n-butyl cellosolve; and ketones such as acetone and methyl ethyl ketone.

The fourth step may include adding a crosslinking agent. This allows, when a coating is formed out of the composition (Z) applied, the carboxy group of the resin (Y) to react to the crosslinking agent through heating and form a crosslinked structure, thereby forming a coating with excellent water resistance. In addition, this further improves the water resistance of even a resin (Y) with a large acid value as well. As the crosslinking agent, a compound with two or more functional groups that react to a carboxy group may be used, for example. Examples of the crosslinking agent include a melamine-based crosslinking agent, an isocyanate-based crosslinking agent, an epoxy-based crosslinking agent, an oxazoline-based crosslinking agent, and a carbodiimide-based crosslinking agent.

The fourth step may include adding suitable additives such as an additional water-based resin other than the resin (Y), a leveling agent, an antioxidant, an ultraviolet absorber, an antifoaming agent, a crosslinking agent, and inorganic particles.

The composition (Z) may be applied easily by, for example, bar coating, dip coating, spray coating, or spin coating.

The resin film (hereinafter also referred to as a “resin film (W)”) made of the water-based coating composition (Z) obtained by the production method (V) has excellent water resistance and excellent adhesion to a resin having a polar structure such as a PET film and to a metal such as aluminum evaporated layers. In addition, the resin film (W) may also keep the haze low and is excellent in transparency. Furthermore, the resin film (W) is also excellent in primer properties, for example.

### Water-Based Coating Composition

The water-based coating composition (composition (Z)) according to this embodiment contains a water-based polyester resin, which includes a neutralized product of the resin (Y). As used herein, the “neutralized product of the water-based polyester resin” refers to a product produced by neutralizing, with a base, part or all of the carboxy group included in the water-based polyester resin.

The composition (Z) may contain, for example, either water or water containing a hydrophilic organic solvent. In that case, the applicability of the composition (Z) may be further increased by, for example, appropriately adjusting the viscosity of the composition (Z). If the composition (Z) contains either water or water containing a hydrophilic organic solvent, then the composition (Z) is a resin dispersion liquid of the resin (Y). This resin dispersion liquid of the resin (Y) is excellent in stability and may keep the resin dispersed for a long time.

The resin film (W) made of the composition (Z) has excellent adhesion to a resin having a polar structure such as a PET film and to a metal such as aluminum evaporated layers. In addition, the resin film (W) may also keep the haze low and is excellent in transparency. Furthermore, the resin film (W) is also excellent in primer properties, for example.

The composition (Z) may contain suitable additives such as an additional water-based resin other than the resin (Y), a leveling agent, an antioxidant, an ultraviolet absorber, an antifoaming agent, a crosslinking agent, and inorganic particles.

As can be seen from the foregoing description, the present disclosure may provide a method for producing a water-based polyester resin having the following advantageous features, and such a water-based polyester resin and a method for producing a water-based coating composition having the following advantageous features, and such a water-based coating composition. Specifically, the water-based polyester resin exhibits not only excellent water resistance and excellent water dispersibility but also excellent stability when used as a resin dispersion liquid while reducing the environmental impact. In addition, the water-based polyester resin includes a terephthalic acid residue derived from a recycled polyester and would still have as good resin properties (such as adhesion and transparency) as in a situation where terephthalic acid or a terephthalic acid derivative not derived from a recycled polyester is used. Furthermore, the resin dispersion liquid of the water-based polyester resin would exhibit not only excellent water dispersibility for a long term but also improved stability such as aging stability in solution haze.

### EXAMPLES

Next, specific examples of the present disclosure will be described. Note that the examples to be described below are only examples of the present disclosure and should not be construed as limiting.

### Producing Water-Based Polyester Resin

Using the materials shown in Table 1 (to be posted later), a water-based polyester resin was produced in the following procedure. Details of the recycled polyester used for production are as follows:
Recycled polyester A: material recycled polyester made from recovered used PET bottles, having an intrinsic viscosity (IV value) of 0.88 dl/g;
Recycled polyester B: material recycled polyester made from recovered used PET bottles, having an intrinsic viscosity (IV value) of 0.67 dl/g;
Recycled polyester C: material recycled polyester made from recovered polyester fiber (PET fiber) wastes, having an intrinsic viscosity (IV value) of 0.59 dl/g; and
Recycled polyester D: material recycled polyester made from recovered PET film wastes, having an intrinsic viscosity (IV value) of 0.50 dl/g.

Note that the intrinsic viscosities (IV values) of the recycled polyesters were determined based on the results of measurement using an Ubbelohde viscometer.

The “intrinsic viscosity” as used herein refers to an intrinsic viscosity measured in compliance with the JIS K 7390-1:2015 standard.

### (1) Production by Procedure (A) (Examples 1, 3, 5, and 7-9 and Comparative Examples 1-3)

### (First Step)

### (Step X1)

A reaction vessel, including a stirrer, a nitrogen gas inlet, a thermometer, a rectification column, and a cooling condenser and having a capacity of 1000 mL, was provided. Into this reaction vessel, introduced were the recycled polyester, the first polycarboxylic acid component, the polyalcohol component, and potassium titanium oxalate (as a catalyst) shown in Table 1 to make a mixture. This mixture was heated to 200° C. while being stirred and mixed in a nitrogen atmosphere under ordinary pressure, and then gradually heated to 250° C. for 7 hours, thereby performing an ester formation reaction and a depolymerization reaction.

### (Second Step)

The temperature of the reaction product of the step X1 was fixed at 200° C. at a normal pressure in a nitrogen atmosphere. In this process step, after the second polycarboxylic acid component shown in Table 1 had been added, the mixture was stirred and mixed for 40 minutes with the temperature kept within the range from 200° C. to 210° C. at a normal pressure in a nitrogen atmosphere, thereby performing the ester formation reaction.

### (Third Step)

After the second step had been performed, the pressure was gradually reduced to 0.67 hPa (0.5 mmHg) at a temperature of 200-210° C. with the mixture stirred and mixed, and this state was maintained for 1 hour, thereby performing a polycondensation reaction. In this manner, a water-based polyester resin was produced.

### (2) Production by Procedure (B) (Examples 2, 4, and 6)

### (First Step)

### (Step X2-1)

A reaction vessel, including a stirrer, a nitrogen gas inlet, a thermometer, a rectification column, and a cooling condenser and having a capacity of 1000 mL, was provided. Into this reaction vessel, introduced were the first polycarboxylic acid component, the polyalcohol component, and potassium titanium oxalate (as a catalyst) shown in Table 1 to make a mixture. This mixture was heated to 200° C. while being stirred and mixed in a nitrogen atmosphere under ordinary pressure, and then gradually heated to 240° C. for 3 hours, thereby performing an ester formation reaction.

### (Step X2-2)

After the step X2-1 had been performed, the recycled polyester shown in Table 1 was introduced into the reaction vessel and heated to 250° C. while being stirred and mixed in a nitrogen atmosphere at a normal pressure and this state was maintained for 5 hours, thereby performing a depolymerization reaction.

### (Second Step)

The temperature of the reaction product of the step X2-2 was fixed at 200° C. at a normal pressure in a nitrogen atmosphere. In this process step, after the second polycarboxylic acid component shown in Table 1 had been added, the mixture was stirred and mixed for 40 minutes with the temperature kept within the range from 200° C. to 210° C. at a normal pressure in a nitrogen atmosphere, thereby performing the ester formation reaction.

### (Third Step)

After the second step had been performed, the pressure was gradually reduced to 0.67 hPa (0.5 mmHg) at a temperature of 200-210° C. with the mixture stirred and mixed, and this state was maintained for 1 hour, thereby performing a polycondensation reaction. In this manner, a water-based polyester resin was produced.

### (3) Reference Examples (Reference Examples 1-3)

The water-based polyester resins representing Examples 3 and 7 and Comparative Example 2 were produced using dimethyl terephthalate as an unused terephthalic acid derivative without using a recycled polyester. In this manner, water-based polyester resins were produced as Reference Examples 1-3.

### Preparation of Water-Based Coating Composition

### (1) Examples 1, 2, 7, and 8

A reaction vessel, including a stirrer, a thermometer, and a cooling condenser and having a capacity of 1000 mL, was provided. Into this reaction vessel, 100 parts by mass of the water-based polyester resin obtained as described above, 288 parts by mass of water, and 12 parts by mass of 25 mass % ammonia aqueous solution as a neutralizing base were introduced. The mixture had its temperature increased to 85° C. while being stirred and mixed. Thereafter, the mixture was maintained at a temperature of 85° C. for 2 hours to neutralize and disperse the water-based polyester resin. In this manner, a water-based coating composition with a resin concentration of 25% by mass was prepared.

### (2) Examples 3-6, and 9 and Comparative Examples 1-3

The water-based polyester resin thus prepared had so low water solubility that the polyester resin could not be dispersed under the condition described in the item (1). Therefore, the water-based polyester resin was dispersed using n-butyl cellosolve as a hydrophilic organic solvent. Specifically, a water-based coating composition having a resin concentration of 25% by mass was prepared by mixing 100 parts by mass of the water-based polyester resin prepared as described above, 20 parts by mass of the n-butyl cellosolve, 274 parts by mass of water, and 6 parts by mass of 25 mass % ammonia aqueous solution as a neutralizing base and increasing the temperature of the mixture to 85° C. while stirring and mixing the mixture. Thereafter, the mixture was maintained at a temperature of 85° C. for two hours, thereby neutralizing and dispersing the water-based polyester resin. In this manner, a water-based coating composition with a resin concentration of 25% by mass was prepared.

### (3) Reference Examples (Reference Examples 1-3)

Water-based coating compositions, each having a resin concentration of 25% by mass, were prepared by applying the method as described in the item (1) to the water-based polyester resins obtained as Reference Examples 1 and 2 and by applying the method as described in the item (2) to the water-based polyester resin obtained as Reference Example 3.

### Evaluation

### [Resin's Physical Properties]

The physical properties of each of the water-based polyester resins produced as described above were evaluated by the following methods.

(Acid Value (mgKOH/g))

The acid value of the water-based polyester resin was determined based on the results of measurement by titration using an ethanol solution of potassium hydroxide.

### (Weight Average Molecular Weight)

The weight average molecular weight of the water-based polyester resin was determined based on the results of measurement by gel permeation chromatography (and was converted into a polystyrene equivalent molecular weight).

### (Glass Transition Temperature (° C.))

The glass transition temperature of the water-based polyester resin was determined based on the results of measurement by differential scanning calorimetry.

### [Measurement of Physical Properties]

Each of the water-based coating compositions (resin dispersion liquids) prepared as described above had its physical properties measured by the following methods:

### (Water Dispersibility)

The resin dispersion liquid was observed and graded as follows from its appearance:
Grade A: if no precipitates were recognized in the resin dispersion liquid;
Grade B: if a very small amount of precipitates was recognized in the resin dispersion liquid;
Grade C: if a lot of precipitates was recognized in the resin dispersion liquid; or
Grade D: if the resin was not dispersed in the solvent.

### (Stability of Resin Dispersion Liquid)

The resin dispersion liquid was put into, and hermetically sealed in, a glass bottle, and allowed to stand still at 20° C. for 15 days. After that, the dispersion liquid was observed and graded as follows from its appearance:
Grade A: if no isolation or precipitate was recognized in the dispersion liquid;
Grade B: if isolation and/or precipitate was recognized a little in the dispersion liquid; or
Grade C: if a lot of isolation and/or precipitate was recognized in the dispersion liquid.

### (Aging Stability in Solution Haze)

The resin dispersion liquids were put into, and hermetically sealed in, glass bottles, and allowed to stand still at 5° C., 20° C., and 30° C., respectively, for 15 days. After that, the haze (%) of each of the dispersion liquids was measured using a haze meter manufactured by Nippon Denshoku Industries Co., Ltd. The dispersion liquid was graded as follows based on the results of the measurement:
Grade A: if the change rate in the haze of the dispersion liquid was less than 20% compared with the haze of the dispersion liquid that had not been allowed to stand still yet;
Grade B: if the change rate in the haze of the dispersion liquid was equal to or greater than 20% and or less than 40% compared with the haze of the dispersion liquid that had not been allowed to stand still yet;
Grade C: if the change rate in the haze of the dispersion liquid was equal to or greater than 40% and or less than 60% compared with the haze of the dispersion liquid that had not been allowed to stand still yet; or
Grade D: if the change rate in the haze of the dispersion liquid was equal to or greater than 60% compared with the haze of the dispersion liquid that had not been allowed to stand still yet or if the haze of the dispersion liquid was equal to or greater than 90%.

### (Adhesion of PET Film)

An untreated biaxially oriented polyethylene terephthalate (PET) film was provided as a base member. The resin dispersion liquid that had been prepared by neutralizing the resin with the base was applied onto this base member using a bar coater, and then heated at 120° C. for 5 minutes. In this manner, a primer layer having a thickness of about 1 μm was formed on the base member out of the resin (Y) from which the base had been removed and in which a carboxy group had been reproduced. Subsequently, a cellophane adhesive tape was brought into close contact with the primer layer on the base member and then peeled off, and the remaining primer layer was observed. The primer layer was graded as follows from its appearance:
Grade A: if no peeling of the primer layer was recognized;
Grade B: if peeling was recognized in some parts of the primer layer; or
Grade C: if peeling was recognized in most of the primer layer.

### (Adhesion of Aluminum Evaporated Layer)

An untreated biaxially oriented polyethylene terephthalate (PET) film was provided as a base member, and a primer layer was formed to a thickness of about 1 μm on the base member by the same method as the one described for the “adhesion of PET film” section. Subsequently, an aluminum evaporated layer was formed by vacuum deposition process to a thickness of about 1 μm on the primer layer on the base member. A cellophane adhesive tape was brought into close contact with the aluminum evaporated layer and then peeled off, and the remaining aluminum evaporated layer was observed. The aluminum evaporated layer was graded as follows from its appearance:
Grade A: if no peeling of the aluminum evaporated layer was recognized;
Grade B: if peeling was recognized in some parts of the aluminum evaporated layer; or
Grade C: if peeling was recognized in most of the aluminum evaporated layer.

### (Water Resistance)

An untreated biaxially oriented polyethylene terephthalate (PET) film was provided as a base member, and a primer layer was formed to a thickness of about 1 μm on the base member by the same method as the one described for the “adhesion of PET film” section. Subsequently, the base member on which the primer layer had been formed was immersed in water at 50° C. for 30 minutes. When 30 minutes passed, the base member was lifted out of the water and was allowed to stand still and be dried in a room at 20° C. for 24 hours. After the base member had been dried, the primer layer on the base member was observed. The primer layer was graded as follows from its appearance:
Grade A: if no whitening or dissolving was recognized in the primer layer;
Grade B: if whitening or dissolving was recognized in some parts of the primer layer; or
Grade C: if whitening or dissolving was recognized in most of the primer layer.

### (Haze)

An untreated biaxially oriented polyethylene terephthalate (PET) film was provided as a base member. The resin dispersion liquid was applied onto this base member using a bar coater, and then heated at 120° C. for 5 minutes. In this manner, a primer layer having a thickness of about 3 μm was formed on the base member. Subsequently, the haze of the base member alone and the haze of the base member and the primer layer combined were measured using a haze meter manufactured by Nippon Denshoku Industries Co., Ltd. The haze (%) of the primer layer was calculated by subtracting the haze of the base member alone from the haze of the base member and the primer layer combined.

The following Table 1 summarizes the evaluation results of physical property tests on the water dispersibility, the stability of the resin dispersion liquid, the aging stability in solution haze, the water resistance, the adhesion of the PET film, the adhesion of aluminum evaporated layer, and the haze.

TABLE 1

| | | | Examples | | | | | | | |
|---|---|---|---|---|---|---|---|---|---|---|
| Amounts of materials used | | | 1 | | 2 | | 3 | | 4 | |
| Reaction | First | Isophthalic acid | 120 | g | 120 | g | 75 | g | 30 | g |
| materials | polycarboxylic | | 0.722 | mol | 0.722 | mol | 0.451 | mol | 0.181 | mol |
| | acid components | | 19.2 | wt % | 19.2 | wt % | 15.0 | wt % | 6.0 | wt % |
| | | 2,6-Naphthalenedicarboxylic | | | | | | | | |
| | | acid dimethyl | | | | | | | | |
| | | Sebacic acid | | | | | | | 45 | g |
| | | | | | | | | | 0.222 | mol |
| | | | | | | | | | 9.0 | wt % |
| | Second | Trimellitic acid | | | 100 | g | 60 | g | | |
| | polycarboxylic | | | | 0.476 | mol | 0.286 | mol | | |
| | acid components | | | | 16.0 | wt % | 12.0 | wt % | | |
| | | Trimellitic acid | 95 | g | | | | | 60 | g |
| | | anhydride | 0.494 | mol | | | | | 0.312 | mol |
| | | | 15.2 | wt % | | | | | 12.0 | wt % |
| | Polycarboxylic | 5-Sodium dimethyl | | | | | | | | |
| | acid compound with | sulfoisophthalate | | | | | | | | |
| | sulfonate group | | | | | | | | | |
| | Terephthalic acid | Dimethyl terephthalate | | | | | | | | |
| | derivative | | | | | | | | | |
| | Polyalcohol | Ethylene glycol | 120 | g | 90 | g | 33 | g | 40 | g |
| | components | | 1.934 | mol | 1.450 | mol | 0.532 | mol | 0.645 | mol |
| | | | 19.2 | wt % | 14.4 | wt % | 6.6 | wt % | 8.0 | wt % |
| | | Diethylene glycol | 40 | g | | | | | | |
| | | | 0.377 | mol | | | | | | |
| | | | 6.4 | wt % | | | | | | |
| | | Neopentyl glycol | | | | | 82 | g | | |
| | | | | | | | 0.787 | mol | | |
| | | | | | | | 16.4 | wt % | | |
| | | 1,2-Propane diol | | | 65 | g | | | | |
| | | | | | 0.854 | mol | | | | |
| | | | | | 10.4 | wt % | | | | |
| | | 1,3-Butane diol | | | | | | | 75 | g |
| | | | | | | | | | 0.832 | mol |
| | | | | | | | | | 15.0 | wt % |
| | Recycled | Recycled PET-A | 250 | g | 250 | g | | | | |
| | Polyesters | | 40.0 | wt % | 40.0 | wt % | | | | |
| | | Recycled PET-B | | | | | 250 | g | 250 | g |
| | | | | | | | 50.0 | wt % | 50.0 | wt % |
| | | Recycled PET-C | | | | | | | | |
| | | Recycled PET-D | | | | | | | | |

| | | | | | | | | | |
|---|---|---|---|---|---|---|---|---|---|
| Catalyst | Potassium titanium oxalate | 0.05 | g | 0.05 | g | 0.05 | g | 0.05 | g |

| | | | | | | | | |
|---|---|---|---|---|---|---|---|---|
| Total of materials compounded | 625.05 | g | 625.05 | g | 500.05 | g | 500.05 | g |

| Polyalcohol component/polycarboxylic | | 1.9/1 | 1.9/1 | 1.8/1 | 2.1/1 |
|---|---|---|---|---|---|
| acid component (molar ratio) | | | | | |
| Terephthalic acid residues (mass %) | | 48.5 | 48.9 | 61.0 | 59.6 |
| derived from recycled polyester | | | | | |
| Divalent polycarboxylic acid residues (mass %) | | 26.9 | 27.2 | 21.2 | 21.3 |
| other than terephthalic acid residues | | | | | |
| Trivalent or higher valent carboxylic | | 24.6 | 23.9 | 17.8 | 19.1 |
| acid residues (mass %) | | | | | |
| Terephthalic acid residues (mass %) | | 0 | 0 | 0 | 0 |
| not derived from recycled polyester | | | | | |
| Resin's | Weight average molecular weight | 6800 | 7100 | 7600 | 8200 |
| physical | Glass transition temperature (° C.) | 63 | 68 | 54 | 28 |
| properties | Acid value (mgKOH/g) | 84 | 92 | 39 | 42 |
| Physical | Water dispersibility | A | A | A | A |
| Property | Stability of resin dispersion liquid | A | A | A | A |
| Tests | Aging stability in solution haze | A | A | A | A |
| | (haze change of dispersion liquid at 5° C.) | | | | |
| | Aging stability in solution haze | B | A | A | A |
| | (haze change of dispersion liquid at 20° C.) | | | | |
| | Aging stability in solution haze | C | A | A | A |
| | (haze change of dispersion liquid at 30° C.) | | | | |
| | Water resistance | B | B | A | B |
| | Adhesion of PET film | A | A | A | A |
| | Adhesion of aluminum evaporated layer | A | A | A | A |
| | Haze (%) | 0.0 | 0.0 | 0.0 | 0.0 |

| | | | Examples | | | | | |
|---|---|---|---|---|---|---|---|---|
| Amounts of materials used | | | 5 | | 6 | | 7 | |
| Reaction | First polycarboxylic | Isophthalic acid | 75 | g | | | 39 | g |
| materials | acid components | | 0.451 | mol | | | 0.235 | mol |
| | | | 15.0 | wt % | | | 8.6 | wt % |
| | | 2,6-Naphthalenedicarboxylic | | | 75 | g | 20 | g |
| | | acid dimethyl | | | 0.307 | mol | 0.082 | mol |
| | | | | | 15.0 | wt % | 4.4 | wt % |
| | | Sebacic acid | | | | | | |
| | Second polycarboxylic | Trimellitic acid | 60 | g | | | | |
| | acid components | | 0.286 | mol | | | | |
| | | | 12.0 | wt % | | | | |
| | | Trimellitic acid | | | 60 | g | 60 | g |
| | | anhydride | | | 0.312 | mol | 0.312 | mol |
| | | | | | 12.0 | wt % | 13.2 | wt % |
| | Polycarboxylic acid | 5-Sodium dimethyl | | | | | | |
| | compound with sulfonate | sulfoisophthalate | | | | | | |
| | group | | | | | | | |
| | Terephthalic acid | Dimethyl terephthalate | | | | | | |
| | derivative | | | | | | | |
| | Polyalcohol | Ethylene glycol | 75 | g | 33 | g | 85 | g |
| | components | | 1.209 | mol | 0.532 | mol | 1.370 | mol |
| | | | 15.0 | wt % | 6.6 | wt % | 18.7 | wt % |
| | | Diethylene glycol | 40 | g | | | | |
| | | | 0.377 | mol | | | | |
| | | | 8.0 | wt % | | | | |
| | | Neopentyl glycol | | | 82 | g | | |
| | | | | | 0.787 | mol | | |
| | | | | | 16.4 | wt % | | |
| | | 1,2-Propane diol | | | | | | |
| | | 1,3-Butane diol | | | | | | |
| | Recycled | Recycled PET-A | | | | | | |
| | polyesters | Recycled PET-B | | | | | | |
| | | Recycled PET-C | 250 | g | 250 | g | 250 | g |
| | | | 50.0 | wt % | 50.0 | wt % | 55.1 | wt % |
| | | Recycled PET-D | | | | | | |

| | | | | | | | |
|---|---|---|---|---|---|---|---|
| Catalyst | Potassium titanium oxalate | 0.05 | g | 0.05 | g | 0.05 | g |

| | | | | | | |
|---|---|---|---|---|---|---|
| Total of materials compounded | 500.05 | g | 500.05 | g | 454.05 | g |

| Polyalcohol component/polycarboxylic | | 2.2/1 | 2.1/1 | 2.2/1 |
|---|---|---|---|---|
| acid component (molar ratio) | | | | |
| Terephthalic acid residues (mass %) | | 61.0 | 60.0 | 63.0 |
| derived from recycled polyester | | | | |
| Divalent polycarboxylic acid residues (mass %) | | 21.2 | 20.8 | 16.8 |
| other than terephthalic acid residues | | | | |
| Trivalent or higher valent carboxylic | | 17.8 | 19.2 | 20.2 |
| acid residues (mass %) | | | | |
| Terephthalic acid residues (mass %) | | 0 | 0 | 0 |
| not derived from recycled polyester | | | | |
| Resin's | Weight average molecular weight | 7800 | 7200 | 8100 |
| physical | Glass transition temperature (° C.) | 46 | 86 | 70 |
| properties | Acid value (mgKOH/g) | 40 | 45 | 60 |
| Physical | Water dispersibility | A | A | A |
| Property | Stability of resin dispersion liquid | A | A | A |
| Tests | Aging stability in solution haze | A | A | B |
| | (haze change of dispersion liquid at 5° C.) | | | |
| | Aging stability in solution haze | B | A | B |
| | (haze change of dispersion liquid at 20° C.) | | | |
| | Aging stability in solution haze | C | A | C |
| | (haze change of dispersion liquid at 30° C.) | | | |
| | Water resistance | A | A | A |
| | Adhesion of PET film | A | B | A |
| | Adhesion of aluminum evaporated layer | A | B | A |
| | Haze (%) | 0.0 | 0.0 | 0.0 |

TABLE 2

| | | | Examples | | | | Comparative Examples | | | | | |
|---|---|---|---|---|---|---|---|---|---|---|---|---|
| Amounts of materials used | | | 8 | | 9 | | 1 | | 2 | | 3 | |
| Reaction | First | Isophthalic acid | 39 | g | 45 | g | 110 | g | 135 | g | 80 | g |
| materials | polycarboxylic | | 0.235 | mol | 0.271 | mol | 0.662 | mol | 0.812 | mol | 0.482 | mol |
| | acid | | 8.6 | wt % | 10.8 | wt % | 24.2 | wt % | 27.0 | wt % | 16.0 | wt % |
| | components | 2,6- | 20 | g | | | | | | | | |
| | | Naphthalenedicarboxylic | 0.082 | mol | | | | | | | | |
| | | acid dimethyl | 4.4 | wt % | | | | | | | | |
| | | Sebacic acid | | | | | | | | | | |
| | Second | Trimellitic acid | | | | | | | | | | |
| | polycarboxylic | Trimellitic acid | 60 | g | 40 | g | | | 20 | g | 20 | g |
| | acid | anhydride | 0.312 | mol | 0.208 | mol | | | 0.104 | mol | 0.104 | mol |
| | components | | 13.2 | wt % | 9.6 | wt % | | | 4.0 | wt % | 4.0 | wt % |
| | Polycarboxylic | 5-Sodium dimethyl | | | | | | | | | 55 | g |
| | acid | sulfoisophthalate | | | | | | | | | 0.186 | mol |
| | compound | | | | | | | | | | 11.0 | wt % |
| | with sulfonate | | | | | | | | | | | |
| | group | | | | | | | | | | | |
| | Terephthalic | Dimethyl terephthalate | | | | | | | | | | |
| | acid derivative | | | | | | | | | | | |
| | Polyalcohol | Ethylene glycol | 55 | g | 45 | g | 94 | g | 95 | g | 95 | g |
| | components | | 0.886 | mol | 0.725 | mol | 1.515 | mol | 1.531 | mol | 1.531 | mol |
| | | | 12.1 | wt % | 10.8 | wt % | 20.7 | wt % | 19.0 | wt % | 19.0 | wt % |
| | | Diethylene glycol | | | | | | | | | | |
| | | Neopentyl glycol | 30 | g | 35 | g | | | | | | |
| | | | 0.288 | mol | 0.336 | mol | | | | | | |
| | | | 6.6 | wt % | 8.4 | wt % | | | | | | |
| | | 1,2-Propane diol | | | | | | | | | | |
| | | 1,3-Butane diol | | | | | | | | | | |
| | Recycled | Recycled PET-A | | | | | 250 | g | | | | |
| | polyesters | | | | | | 55.1 | wt % | | | | |
| | | Recycled PET-B | | | | | | | 250 | g | | |
| | | | | | | | | | 50.0 | wt % | | |
| | | Recycled PET-C | 250 | g | | | | | | | 250 | g |
| | | | 55.1 | wt % | | | | | | | 50.0 | wt % |
| | | Recycled PET-D | | | 250 | g | | | | | | |
| | | | | | 60.2 | wt % | | | | | | |

| | | | | | | | | | | | |
|---|---|---|---|---|---|---|---|---|---|---|---|
| Catalyst | Potassium titanium oxalate | 0.05 | g | 0.05 | g | 0.05 | g | 0.05 | g | 0.05 | g |

| | | | | | | | | | | |
|---|---|---|---|---|---|---|---|---|---|---|
| Total of materials compounded | 454.05 | g | 415.05 | g | 454.05 | g | 500.05 | g | 500.05 | g |

| Polyalcohol component/polycarboxylic | | 1.9/1 | 2.2/1 | 2.3/1 | 1.7/1 | 2.0/1 |
|---|---|---|---|---|---|---|
| acid component (molar ratio) | | | | | | |
| Terephthalic acid residues (mass %) | | 63.0 | 70.3 | 66.3 | 57.8 | 63.7 |
| derived from recycled polyester | | | | | | |
| Divalent polycarboxylic acid residues (mass %) | | 16.8 | 14.6 | 33.7 | 36.1 | 29.5 |
| other than terephthalic acid residues | | | | | | |
| Trivalent or higher valent carboxylic | | 20.2 | 15.0 | 0.0 | 6.2 | 6.8 |
| acid residues (mass %) | | | | | | |
| Terephthalic acid residues (mass %) | | 0 | 0 | 0 | 0 | 0 |
| not derived from recycled polyester | | | | | | |
| Resin's | Weight average molecular weight | 8900 | 8800 | 6100 | 10800 | 9200 |
| physical | Glass transition temperature (° C.) | 78 | 62 | 60 | 58 | 56 |
| properties | Acid value (mgKOH/g) | 54 | 33 | 2 | 18 | 16 |
| Physical | Water dispersibility | A | A | D | C | A |
| Property | Stability of resin dispersion liquid | A | A | — | C | C |
| Tests | Aging stability in solution haze | A | B | — | C | B |
| | (haze change of dispersion liquid at 5° C.) | | | | | |
| | Aging stability in solution haze | A | B | — | D | D |
| | (haze change of dispersion liquid at 20° C.) | | | | | |
| | Aging stability in solution haze | A | B | — | D | D |
| | (haze change of dispersion liquid at 30° C.) | | | | | |
| | Water resistance | A | A | — | A | C |
| | Adhesion of PET film | A | A | — | C | A |
| | Adhesion of aluminum evaporated layer | A | A | — | C | A |
| | Haze (%) | 0.0 | 0.0 | — | 0.7 | 0.0 |

| | | | Reference Examples | | | | | |
|---|---|---|---|---|---|---|---|---|
| Amounts of materials used | | | 1 | | 2 | | 3 | |
| Reaction | First polycarboxylic | Isophthalic acid | 39 | g | 75 | g | 135 | g |
| materials | acid components | | 0.235 | mol | 0.451 | mol | 0.812 | mol |
| | | | 6.5 | wt % | 12.8 | wt % | 21.3 | wt % |
| | | 2,6-Naphthalenedicarboxylic | 20 | g | | | | |
| | | acid dimethyl | 0.082 | mol | | | | |
| | | | 3.3 | wt % | | | | |
| | | Sebacic acid | | | | | | |
| | Second polycarboxylic | Trimellitic acid | | | 60 | g | | |
| | acid components | | | | 0.286 | mol | | |
| | | | | | 10.3 | wt % | | |
| | | Trimellitic acid | 60 | g | | | 20 | g |
| | | anhydride | 0.312 | mol | | | 0.104 | mol |
| | | | 10.0 | wt % | | | 3.2 | wt % |
| | Polycarboxylic acid compound | 5-Sodium dimethyl | | | | | | |
| | with sulfonate group | sulfoisophthalate | | | | | | |
| | Terephthalic acid | Dimethyl terephthalate | 253 | g | 253 | g | 253 | g |
| | derivative | | 1.303 | mol | 1.303 | mol | 1.303 | mol |
| | | | 42.0 | wt % | 43.3 | wt % | 40.0 | wt % |
| | Polyalcohol components | Ethylene glycol | 230 | g | 114 | g | 225 | g |
| | | | 3.706 | mol | 1.836 | mol | 3.626 | mol |
| | | | 38.2 | wt % | 19.5 | wt % | 35.5 | wt % |
| | | Diethylene glycol | | | | | | |
| | | Neopentyl glycol | | | 82 | g | | |
| | | | | | 0.787 | mol | | |
| | | | | | 14.0 | wt % | | |
| | | 1,2-Propane diol | | | | | | |
| | | 1,3-Butane diol | | | | | | |
| | Recycled | Recycled PET-A | | | | | | |
| | polyesters | Recycled PET-B | | | | | | |
| | | Recycled PET-C | | | | | | |
| | | Recycled PET-D | | | | | | |

| | | | | | | | |
|---|---|---|---|---|---|---|---|
| Catalyst | Potassium titanium oxalate | 0.10 | g | 0.10 | g | 0.10 | g |

| | | | | | | |
|---|---|---|---|---|---|---|
| Total of materials compounded | 602.1 | g | 584.1 | g | 633.1 | g |

| Polyalcohol component/polycarboxylic | | 1.9/1 | 1.3/1 | 1.6/1 |
|---|---|---|---|---|
| acid component (molar ratio) | | | | |
| Terephthalic acid residues (mass %) | | 0 | 0 | 0 |
| derived from recycled polyester | | | | |
| Divalent polycarboxylic acid residues (mass %) | | 16.8 | 21.1 | 36.0 |
| other than terephthalic acid residues | | | | |
| Trivalent or higher valent carboxylic | | 20.1 | 17.8 | 6.2 |
| acid residues (mass %) | | | | |
| Terephthalic acid residues (mass %) | | 63.0 | 61.0 | 57.8 |
| not derived from recycled polyester | | | | |
| Resin's | Weight average molecular weight | 8300 | 7600 | 10100 |
| physical | Glass transition temperature (° C.) | 70 | 54 | 56 |
| properties | Acid value (mgKOH/g) | 62 | 39 | 15 |
| Physical | Water dispersibility | A | A | C |
| Property | Stability of resin dispersion liquid | A | A | C |
| Tests | Aging stability in solution haze | B | A | C |
| | (haze change of dispersion liquid at 5° C.) | | | |
| | Aging stability in solution haze | B | A | D |
| | (haze change of dispersion liquid at 20° C.) | | | |
| | Aging stability in solution haze | B | A | D |
| | (haze change of dispersion liquid at 30° C.) | | | |
| | Water resistance | A | A | A |
| | Adhesion of PET film | A | A | C |
| | Adhesion of aluminum evaporated layer | A | A | C |
| | Haze (%) | 0.0 | 0.0 | 0.6 |

As can be seen from the results shown in Tables 1 and 2, the water-based polyester resin produced by the production method according to Examples 1-9 exhibited not only excellent water resistance and excellent water dispersibility but also excellent stability when used as a resin dispersion liquid while reducing the environmental impact. In addition, the water-based polyester resin included a terephthalic acid residue derived from a recycled polyester and still had as good resin properties (such as adhesion and transparency) as in a situation where terephthalic acid or a terephthalic acid derivative not derived from a recycled polyester was used. Furthermore, the resin dispersion liquid of the water-based polyester resin exhibited not only excellent water dispersibility for a long term but also improved stability such as aging stability in solution haze.

On the other hand, the water-based polyester resin produced by the production method according to Comparative Example 1 could not be dispersed in water or water containing a hydrophilic organic solvent without using a surfactant, for example. The water-based polyester resin produced by the production method according to any of Comparative Examples 2 and 3 was inferior in the stability of the resin dispersion liquid and aging stability in solution haze.

### (Recapitulation)

As can be seen from the foregoing description of embodiments and examples, a method for producing a water-based polyester resin according to a first aspect of the present disclosure is a method for producing a water-based polyester resin using a recycled polyester. The method includes a first step, a second step, and a third step. The first step includes performing an ester formation reaction and a depolymerization reaction using the recycled polyester, a first polycarboxylic acid component including a divalent polycarboxylic acid residue other than a terephthalic acid residue, and a polyalcohol component. The second step includes performing an ester formation reaction using a reaction product of the first step and a second polycarboxylic acid component including a trivalent or higher valent polycarboxylic acid residue. The third step includes performing a polycondensation reaction by reducing pressure. The first step includes using the recycled polyester to such an amount that makes proportion of the terephthalic acid residue with respect to a total of the terephthalic acid residue included in the recycled polyester and the respective polycarboxylic acid residues included in the first and second polycarboxylic acid components equal to or greater than 20% by mass and equal to or less than 72% by mass. The water-based polyester resin thus produced has an acid value equal to or greater than 30 mgKOH/g and equal to or less than 120 mgKOH/g.

The first aspect allows a water-based polyester resin having the following advantageous features to be produced. Specifically, this water-based polyester resin would exhibit not only excellent water resistance and excellent water dispersibility but also excellent stability when used as a resin dispersion liquid while reducing the environmental impact. In addition, this polyester resin includes a terephthalic acid residue derived from a recycled polyester and would still have as good resin properties (such as adhesion and transparency) as in a situation where terephthalic acid or a terephthalic acid derivative not derived from a recycled polyester is used. Furthermore, the resin dispersion liquid of this polyester resin would exhibit not only excellent water dispersibility for a long term but also improved stability such as aging stability in solution haze.

In a method for producing a water-based polyester resin according to a second aspect, which may be implemented in conjunction with the first aspect, the first step includes performing the ester formation reaction and the depolymerization reaction after having compounded the recycled polyester, the first polycarboxylic acid component, and the polyalcohol component with each other.

The second aspect allows a water-based polyester resin to be produced by a simpler method.

In a method for producing a water-based polyester resin according to a third aspect, which may be implemented in conjunction with the first aspect, the first step includes: performing the ester formation reaction after having compounded the first polycarboxylic acid component and the polyalcohol component with each other; and performing the depolymerization reaction after having compounded the recycled polyester with a reaction product of the ester formation reaction.

The third aspect allows the depolymerization reaction of the recycled polyester to be performed more appropriately by separately conducting compounding and reaction in these two steps, thus further improving the water dispersibility of the water-based polyester resin and the stability of the resin dispersion liquid.

In a method for producing a water-based polyester resin according to a fourth aspect, which may be implemented in conjunction with any one of the first to third aspects, the first step includes using the first polycarboxylic acid component to such an amount that makes proportion of the divalent polycarboxylic acid residue with respect to the total of the terephthalic acid residue included in the recycled polyester and the respective polycarboxylic acid residues included in the first and second polycarboxylic acid components equal to or greater than 5% by mass and equal to or less than 50% by mass.

The fourth aspect may decrease the degree of crystallinity of the water-based polyester resin more adequately, thereby further improving the water dispersibility and the stability of the resin dispersion liquid.

In a method for producing a water-based polyester resin according to a fifth aspect, which may be implemented in conjunction with any one of the first to fourth aspects, the second step includes using the second polycarboxylic acid component to such an amount that makes proportion of the trivalent or higher valent polycarboxylic acid residue with respect to the total of the terephthalic acid residue included in the recycled polyester and the respective polycarboxylic acid residues included in the first and second polycarboxylic acid components equal to or greater than 10% by mass and equal to or less than 30% by mass.

The fifth aspect may make the acid value of the water-based polyester resin a more adequate value. Consequently, this further improves the water resistance of the water-based polyester resin, thus allowing the resin dispersion liquid of this water-based polyester resin to exhibit not only excellent water dispersibility for a long term but also improved stability such as aging stability in solution haze.

In a method for producing a water-based polyester resin according to a sixth aspect, which may be implemented in conjunction with any one of the first to fifth aspects, neither the first polycarboxylic acid component nor the second polycarboxylic acid component contains any polycarboxylic acid compound having a metal sulfonate group.

The sixth aspect may reduce the chances of causing a decline in the water resistance of the water-based polyester resin.

In a method for producing a water-based polyester resin according to a seventh aspect, which may be implemented in conjunction with any one of the first to sixth aspects, the polyalcohol component contains no trihydric or higher hydric polyalcohol compounds.

The seventh aspect allows the water-based polyester resin to have an even smaller number of crosslinked structures formed due to the presence of trihydric or higher hydric polyalcohol compounds. Consequently, the water dispersibility of the water-based polyester resin and the stability of the resin dispersion liquid thereof are further improvable.

In a method for producing a water-based polyester resin according to an eighth aspect, which may be implemented in conjunction with any one of the first to seventh aspects, the polyalcohol component contains a dihydric alcohol compound. The dihydric alcohol compound has a branched chain. Proportion of a residue of the dihydric alcohol compound having the branched chain is equal to or greater than 10% by mass and equal to or less than 90% by mass with respect to an entire polyalcohol residue included in the water-based polyester resin.

The eighth aspect allows the resin dispersion liquid of the water-based polyester resin to further improve its stability such as aging stability in solution haze.

A method for producing a water-based coating composition according to a ninth aspect of the present disclosure includes: the method for producing the water-based polyester resin according to any one of the first to eighth aspects; and neutralizing, with a base, at least a part of a carboxy group of the water-based polyester resin.

The ninth aspect provides a water-based coating composition in which a water-based polyester resin is dispersed more uniformly.

A water-based polyester resin according to a tenth aspect of the present disclosure contains: a terephthalic acid residue derived from a recycled polyester; and a polycarboxylic acid residue other than the terephthalic acid residue. The polycarboxylic acid residue includes a first polycarboxylic acid residue and a second polycarboxylic acid residue. The first polycarboxylic acid residue is divalent. The second polycarboxylic acid residue is trivalent or higher valent. Proportion of the terephthalic acid residue with respect to a total of the terephthalic acid residue, the first polycarboxylic acid residue, and the second polycarboxylic acid residue is equal to or greater than 20% by mass and equal to or less than 72% by mass. The water-based polyester resin has an acid value equal to or greater than 30 mgKOH/g and equal to or less than 120 mgKOH/g.

The tenth aspect provides a water-based polyester resin having the following advantageous features. Specifically, this water-based polyester would exhibit not only excellent water resistance and excellent water dispersibility but also excellent stability when used as a resin dispersion liquid while reducing the environmental impact. In addition, the water-based polyester resin includes a terephthalic acid residue derived from a recycled polyester and would still have as good resin properties (such as adhesion and transparency) as in a situation where terephthalic acid or a terephthalic acid derivative not derived from a recycled polyester is used. Furthermore, the resin dispersion liquid of this water-based polyester resin would exhibit not only excellent water dispersibility for a long term but also improved stability such as aging stability in solution haze.

In a water-based polyester resin according to an eleventh aspect, which may be implemented in conjunction with the tenth aspect, the proportion of the first polycarboxylic acid residue with respect to the total of the terephthalic acid residue, the first polycarboxylic acid residue, and the second polycarboxylic acid residue is equal to or greater than 5% by mass and equal to or less than 50% by mass.

The eleventh aspect allows the water-based polyester resin to have its degree of crystallinity decreased more adequately and have the water dispersibility and the stability of the resin dispersion liquid thereof further improved.

In a water-based polyester resin according to a twelfth aspect, which may be implemented in conjunction with the tenth or eleventh aspect, proportion of the second polycarboxylic acid residue with respect to the total of the terephthalic acid residue, the first polycarboxylic acid residue, and the second polycarboxylic acid residue is equal to or greater than 10% by mass and equal to or less than 30% by mass.

The twelfth aspect may make the acid value of the water-based polyester resin a more adequate value. Consequently, this further improves the water resistance of the water-based polyester resin, thus allowing the resin dispersion liquid of this water-based polyester resin to exhibit not only excellent water dispersibility for a long term but also improved stability such as aging stability in solution haze.

In a water-based polyester resin according to a thirteenth aspect, which may be implemented in conjunction with any one of the tenth to twelfth aspects, neither the first polycarboxylic acid residue nor the second polycarboxylic acid residue includes any polycarboxylic acid residue having a metal sulfonate group.

The thirteenth aspect may reduce the chances of causing a decline in the water resistance of the water-based polyester resin.

A water-based polyester resin according to a fourteenth aspect, which may be implemented in conjunction with any one of the tenth to thirteenth aspects, further contains a polyalcohol residue. The polyalcohol residue includes no residues of a trihydric or higher hydric polyalcohol compound.

The fourteenth aspect allows the water-based polyester resin to have an even smaller number of crosslinked structures formed due to the presence of trihydric or higher hydric polyalcohol compounds. Consequently, the water dispersibility of the water-based polyester resin and the stability of the resin dispersion liquid thereof are further improvable.

A water-based polyester resin according to a fifteenth aspect, which may be implemented in conjunction with any one of the tenth to thirteenth aspects, further contains a polyalcohol residue. The polyalcohol residue includes a dihydric alcohol compound residue. The dihydric alcohol compound residue has a branched chain. Proportion of the dihydric alcohol compound residue having the branched chain is equal to or greater than 10% by mass and equal to or less than 90% by mass with respect to an entire polyalcohol residue included in the water-based polyester resin.

The fifteenth aspect allows the resin dispersion liquid of the water-based polyester resin to further improve its stability such as aging stability in solution haze.

A water-based coating composition according to a sixteenth aspect of the present disclosure contains a water-based polyester resin. The water-based polyester resin includes a neutralized product of the water-based polyester resin according to any one of the tenth to fifteenth aspects.

The sixteenth aspect provides a water-based coating composition in which the water-based polyester resin is dispersed more uniformly.

1. A method for producing a water-based polyester resin using a recycled polyester, the method comprising:
a first step including performing an ester formation reaction and a depolymerization reaction using the recycled polyester, a first polycarboxylic acid component including a divalent polycarboxylic acid residue other than a terephthalic acid residue, and a polyalcohol component;
a second step including performing an ester formation reaction using a reaction product of the first step and a second polycarboxylic acid component including a trivalent or higher valent polycarboxylic acid residue; and
a third step including performing a polycondensation reaction by reducing pressure,
the first step including using the recycled polyester to such an amount that makes proportion of the terephthalic acid residue with respect to a total of the terephthalic acid residue included in the recycled polyester and the respective polycarboxylic acid residues included in the first and second polycarboxylic acid components equal to or greater than 20% by mass and equal to or less than 72% by mass, and
the water-based polyester resin thus produced having an acid value equal to or greater than 30 mgKOH/g and equal to or less than 120 mgKOH/g.

2. The method of claim 1, wherein
the first step includes performing the ester formation reaction and the depolymerization reaction after having compounded the recycled polyester, the first polycarboxylic acid component, and the polyalcohol component with each other.

3. The method of claim 1, wherein
the first step includes:
performing the ester formation reaction after having compounded the first polycarboxylic acid component and the polyalcohol component with each other; and
performing the depolymerization reaction after having compounded the recycled polyester with a reaction product of the ester formation reaction.

4. The method of claim 1, wherein
the first step includes using the first polycarboxylic acid component to such an amount that makes proportion of the divalent polycarboxylic acid residue with respect to the total of the terephthalic acid residue included in the recycled polyester and the respective polycarboxylic acid residues included in the first and second polycarboxylic acid components equal to or greater than 5% by mass and equal to or less than 50% by mass.

5. The method of claim 1, wherein
the second step includes using the second polycarboxylic acid component to such an amount that makes proportion of the trivalent or higher valent polycarboxylic acid residue with respect to the total of the terephthalic acid residue included in the recycled polyester and the respective polycarboxylic acid residues included in the first and second polycarboxylic acid components equal to or greater than 10% by mass and equal to or less than 30% by mass.

6. The method of claim 1, wherein
neither the first polycarboxylic acid component nor the second polycarboxylic acid component contains any polycarboxylic acid compound having a metal sulfonate group.

7. The method of claim 1, wherein
the polyalcohol component contains no trihydric or higher hydric polyalcohol compounds.

8. The method of claim 1, wherein
the polyalcohol component contains a dihydric alcohol compound,
the dihydric alcohol compound has a branched chain, and
proportion of a residue of the dihydric alcohol compound having the branched chain is equal to or greater than 10% by mass and equal to or less than 90% by mass with respect to an entire polyalcohol residue included in the water-based polyester resin.

9. A method for producing a water-based coating composition, the method comprising:
the method for producing the water-based polyester resin according to claim 1; and
neutralizing, with a base, at least a part of a carboxy group of the water-based polyester resin.

10. A water-based polyester resin containing: a terephthalic acid residue derived from a recycled polyester; and a polycarboxylic acid residue other than the terephthalic acid residue,
the polycarboxylic acid residue including a first polycarboxylic acid residue and a second polycarboxylic acid residue, the first polycarboxylic acid residue being divalent, the second polycarboxylic acid residue being trivalent or higher valent,
proportion of the terephthalic acid residue with respect to a total of the terephthalic acid residue, the first polycarboxylic acid residue, and the second polycarboxylic acid residue being equal to or greater than 20% by mass and equal to or less than 72% by mass, and
the water-based polyester resin having an acid value equal to or greater than 30 mgKOH/g and equal to or less than 120 mgKOH/g.

11. The water-based polyester resin of claim 10, wherein
proportion of the first polycarboxylic acid residue with respect to the total of the terephthalic acid residue, the first polycarboxylic acid residue, and the second polycarboxylic acid residue is equal to or greater than 5% by mass and equal to or less than 50% by mass.

12. The water-based polyester resin of claim 10, wherein
proportion of the second polycarboxylic acid residue with respect to the total of the terephthalic acid residue, the first polycarboxylic acid residue, and the second polycarboxylic acid residue is equal to or greater than 10% by mass and equal to or less than 30% by mass.

13. The water-based polyester resin of claim 10, wherein
neither the first polycarboxylic acid residue nor the second polycarboxylic acid residue includes any polycarboxylic acid residue having a metal sulfonate group.

14. The water-based polyester resin of claim 10, further containing a polyalcohol residue, wherein
the polyalcohol residue includes no residues of a trihydric or higher hydric polyalcohol compound.

15. The water-based polyester resin of claim 10, further containing a polyalcohol residue, wherein
the polyalcohol residue includes a dihydric alcohol compound residue,
the dihydric alcohol compound residue has a branched chain, and
proportion of the dihydric alcohol compound residue having the branched chain is equal to or greater than 10% by mass and equal to or less than 90% by mass with respect to an entire polyalcohol residue included in the water-based polyester resin.

16. A water-based coating composition containing a water-based polyester resin,
the water-based polyester resin including a neutralized product of the water-based polyester resin of claim 10.
